(19) United States
(12) Patent Application Publication
(10) Pub. No.: US 2025/0336058 A1
(43) Pub. Date: Oct. 30, 2025

(54) Empty Container Detection by Perturbation

(71) Applicant: ABB Schweiz AG, Baden (CH)

(72) Inventors: Matt Simkins, Campbell, CA (US); Lawrence Chen, Vancouver, WA (US); Sriharsha Vardhan, San Jose, CA (US); Thomas-Tianwei Wang, Milpitas, CA (US)

(73) Assignee: ABB Schweiz AG, Baden (CH)

(21) Appl. No.: 18/868,261

(22) PCT Filed: May 31, 2022
(86) PCT No.: PCT/IB2022/055091

§ 371 Date: Nov. 22, 2024

(51) Int. Cl. G06T 7/00

(52) U.S. Cl. CPC G06T 7/001; G06T 7/0008; G06T 2207/30112; G06T 2210/12

(57) ABSTRACT

A computer-implemented method for detecting empty container includes acquiring a first image of a container using an imaging system, and after the first image is acquired, causing a perturbation device to perturb a content of the container. The method further includes acquiring a second image of the container using the imaging system after the perturbation, and processing the first image and the second image using one or more computer processors, to determine whether the container is empty based on whether there is a difference between the first image and the second image as a result of one or more objects inside the container being moved due to the perturbation.

### FIELD

Embodiments of the present invention relate to a method, system and computer-readable medium for detecting empty containers. Such method, system, and computer-readable medium can be applied in systems which utilize robots to pick items from containers, such as in some automated storage and retrieval systems (AS/RS).

### BACKGROUND

An automated storage and retrieval system (AS/RS) can utilize containers (also referred to as totes) to hold a variety of objects (e.g., work parts for an assembly line or inventory in a fulfillment center). The containers can be transported in logistics facilities using various conveyor systems. In automated logistics facilities, objects can be inserted into and removed from a container by a machine such as a robot. When all objects are removed from the container, the robot would need to stop picking from the container. Therefore, it may be necessary for a control system of the robot to determine that the container is empty, and possibly also report the empty container to the AS/RS. If the control system of the robot is unable to accurately determine whether the container is empty, the robot may attempt to pick indefinitely from the container for non-existent objects, or may report inaccurate information to the AS/RS inventory tracking system. In addition, the AS/RS may also need to determine whether a container being used to deposit objects is empty.

One way of determining whether a container is empty is to use a weight scale to weigh the container and compare the current weight against a known weight of the container when the container is empty. However, the weight method can have some limitations. For example, weight scales may not be easily integrated with a conveyor system, the check process can be slow, or the presence of light-weight objects may not be detected. Also, the check might be specific to the weight being used.

Machine vision systems using cameras can be attractive, as they can be fast and inexpensive. However, visual processing algorithms may not be sufficiently robust. For instance, comparing an image of a container to a reference image of an empty container (also referred to as a ground truth image) might produce a false determination due to image differences that are unrelated to the objects that are inserted into and removed out of the container. For example, the machine vision system might erroneously detect dirt smudges, scratches, or dents on the container and classify them as objects. Such systems may also be specific to a particular container type. Machine vision systems can also be sensitive to lighting conditions. Depth sensors might fail to detect small or flat objects that can blend in with the base or walls of the container. Therefore, fast and reliable methods of determining whether a container is empty are needed.

### SUMMARY

According to some embodiments, a computer-implemented method for detecting empty container includes acquiring a first image of a container using an imaging system, and after the first image is acquired, causing a perturbation device to perturb a content of the container. The method further includes acquiring a second image of the container using the imaging system after the perturbation, and processing the first image and the second image using one or more computer processors, to determine whether the container is empty based on whether there is a difference between the first image and the second image as a result of one or more objects inside the container being moved due to the perturbation.

According to some embodiments, a system for detecting empty container includes a perturbation device for perturbing a content of a container, and an imaging system for acquiring a first image and a second image of the container. The first image is acquired before the perturbation, and the second image is acquired after the perturbation. The system further includes one or more computer processors configured to process the first image and the second image, to determine whether the container is empty based on whether there is a difference between the first image and the second image as a result of one or more objects inside the container being moved due to the perturbation.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1A-1D and 2A-2C illustrate an image processing method for comparing two images of a container before and after the container has been perturbed, according to some embodiments.

FIGS. 3A and 3B show two images of a container before and after the container has been perturbed, according to some embodiments.

FIGS. 4A and 3B show two images of a container before and after the container has been perturbed, according to some embodiments.

FIG. 5 is a flowchart illustrating a computer-implemented method for detecting empty container according to some embodiments.

FIG. 6 is a simplified block diagram of a system for detecting empty container according to some embodiments.

### DETAILED DESCRIPTION

Embodiments of the present invention provide methods for determining whether a container is empty using a machine vision system in combination with a perturbation apparatus. The machine vision system can include one or more cameras and/or sensors. The cameras can be two-dimensional (2D) cameras and/or three-dimensional (3D) cameras. The sensors can include radars, lidars, ultrasonic sensors, and the like. Images captured by the cameras/sensors immediately before and immediately after a perturbation are compared with each other to determine whether the container is empty. The methods can afford numerous advantages, such as being fast and inexpensive, independent of lighting conditions and container type, applicable to a wide range of object size and object weight, and immune from spoofing by smudges or damages to the inside of a container.

According to some embodiments, a method for determining whether a container is empty can include the following steps. First, a first image of the container is acquired. Second, a perturbation to a content of the container is performed. For example, the perturbation can be performed by shaking the container or tilting the container, moving a robot end effector along the inside of the container as if to stir potential objects within the container, or by blowing compressed air into the container. Third, immediately after the container is perturbed, a second image of the container is acquired. If the perturbation is performed by a robot, the robot may be moved out of the field of view before the second image is acquired. Forth, the first image and the second image are compared using an image comparison algorithm to determine whether the container is empty.

According to some embodiments, if it is determined that the second image is the same as the first image (e.g., using a threshold), it can be determined that the container does not contain any object (e.g., the container is empty). The robot or the AS/RS can take appropriate actions accordingly (e.g., removing the empty container from the conveyer, re-filling the empty container with work parts, or the like). On the other hand, if it is determined that the second image differs from the first image by more than the threshold, it can be determined that the container contains one or more objects that have been displaced and/or re-orientated as a result of the perturbation. It may be preferable that the threshold be generic enough to ensure that the image comparison algorithm is agnostic to the size, shape, color, and texture of the objects, as well as their distance from the camera and illumination level. Since the first image and the second image are taken of the same container under identical environmental conditions (e.g., the lighting condition), any differences between the first image and the second image are likely due to objects inside the container being moved as a result of the perturbation.

In the discussion below, it may be assumed that the container has an open top. However, the methods described herein are applicable to other types of containers. Various devices can be used to perturb a container according to various embodiments. For example, such devices can include an end effector of a robot, a shaker, an air nozzle, or a combination thereof. In an exemplary embodiment, perturbation can be performed by using compressed air. A robot end effector can be equipped with one or more air nozzles located near a gripper. For example, air nozzles can be useful for repositioning of objects that have an unfavorable position or unfavorable orientation for pick points. With the robot end effector being inside a container, compressed air can be blown from the nozzles to move objects that are possibly in the container. Preferably, the air blast should not be so strong so as not to knock objects out of the container, and yet not so weak that it is unable to jostle objects in the container. In some embodiments, the robot can be the same robot that is used to pick the objects from the container. In some other embodiments, the robot can be another robot that performs other tasks or can be a dedicated robot. In some embodiments, the air nozzles can be independent of any robot.

Various image sensing devices can be used for the machine vision system. For example, the image sensing devices can include 2D cameras, RGBD cameras, 3D cameras (e.g., structured light cameras, radars, lidars, and the like), ultrasonic sensors, and the like. The machine vision system can include a single image sensing device (e.g., an RGBD camera), or multiple image sensing devices. Different types of image sensing devices can be combined (e.g., an RGBD camera combined with an RGB camera, or a RGB camera combined with a lidar). In an exemplary embodiment, two cameras are used. In case an object close to a first camera is occluded by the inner wall of the container, the object may be captured by a second camera. Two cameras pointing into the container from opposite vantage points tend to see everything in the “crossfire.”

Various image processing algorithms can be used for comparing the images before and after the container is perturbed. In some exemplary embodiments, the mean square error (MSE) method and the structural similarity index measure (SSIM) method are employed. The MSE method may focus on the absolute pixelwise errors. An MSE between two greyscale images can be calculated as the following:

$$M S E = \frac{1}{m n} {\sum }_{i = 0}^{m - 1} {\sum }_{j = 0}^{n - 1} {[ I ( i , j ) - K ( i , j ) ]}^{2} ,$$

where I(i, j) is the intensity of the pixel (i, j) of the first image, and K(i, j) is the intensity of the pixel (i, j) of the second image. The MSE value would be zero if the two images are identical, and would be greater than zero if the two images differ.

The SSIM method may focus on the structural information, such as the inter-dependencies between pixels. The SSIM index is calculated on various windows of an image. The measure between two windows x and y of common size N×N can be calculated as the following:

$$S S I M ( x , y ) = \frac{( 2 {μ}_{x} {μ}_{y} + {c}_{1} ) ( 2 {σ}_{x y} + {c}_{2} )}{( {μ}_{x}^{2} + {μ}_{y}^{2} + {c}_{1} ) ( {σ}_{x}^{2} + {σ}_{y}^{2} + {c}_{2} )} ,$$

where μₓ is the average of x, μ_{y} is the average of y,

$${σ}_{x}^{2}$$

is the variance or x,

$${σ}_{y}^{2}$$

is the variance of y, σ_{xy} is the covariance of x and y, c₁=(k₁L)², c₂=(k₂L)², L is the dynamic range of the pixel-values (e.g., 2^{#bits per pixel}−1), k₁=0.01, and k₂=0.03 by default. The SSIM value would be equal to unity (“1”) if the two images are identical, and would be less than unity if the two images differ.

As described above and below, embodiments of the present invention provide a method, a system, and a computer-readable medium for determining whether a container is empty using machine vision in combination with a perturbation apparatus.

In a first aspect, the present invention provides a computer-implemented method for detecting empty container. The method includes acquiring, using an imaging system, a first image of a container, after the first image is acquired, causing a perturbation device to perturb a content of the container, acquiring, using the imaging system, a second image of the container after the perturbation, and processing, using one or more computer processors, the first image and the second image to determine whether the container is empty based on whether there is a difference between the first image and the second image as a result of one or more objects inside the container being moved due to the perturbation.

In a second aspect, the present invention provides the method according to the first aspect, wherein the perturbation is performed by blowing air inside the container.

In a third aspect, the present invention provides the method according to the first aspect, wherein the perturbation is performed by moving a robot end effector along an inside of the container in a stirring motion.

In a fourth aspect, the present invention provides the method according to the first aspect, wherein the perturbation is performed by shaking or tilting the container.

In a fifth aspect, the present invention provides the method according to the first aspect, wherein the first image and the second image are acquired under a same set of environmental conditions.

In a sixth aspect, the present invention provides the method according to the first aspect, wherein processing the first image and the second image includes comparing the first image and the second image by evaluating a value of a mean squared error (MSE) function between the first image and the second image, determining that the container is empty upon determining that the value of the MSE function is less than a pre-defined threshold value, and determining that the container is not empty upon determining that the value of the MSE function is equal to or greater than the pre-defined threshold value.

In a seventh aspect, the present invention provides the method according to the sixth aspect, wherein processing the first image and the second image further includes, before evaluating the value of the MSE function, applying a blur function to the first image and the second image.

In an eighth aspect, the present invention provides the method according to the sixth aspect, wherein processing the first image and the second image further includes, before evaluating the value of the MSE function, converting the first image and the second image into greyscale images.

In an ninth aspect, the present invention provides the method according to the first aspect, wherein processing the first image and the second image includes comparing the first image and the second image by evaluating a value of a structural similarity index measure (SSIM) function between the first image and the second image, determining that the container is empty upon determining that a difference between the value of the SSIM function and unity is less than a pre-defined threshold amount, and determining that the container is not empty upon determining that the difference between the value of the SSIM function and unity is equal to or greater than the pre-defined threshold amount.

In a tenth aspect, the present invention provides the method according to the ninth aspect, wherein processing the first image and the second image further includes, before evaluating the value of the SSIM function, applying a blur function to the first image and the second image.

In a eleventh aspect, the present invention provides the method according to the ninth aspect, wherein processing the first image and the second image further includes, before evaluating the value of the SSIM function, converting the first image and the second image into greyscale images.

In an twelfth aspect, the present invention provides the method according to the first aspect, the method further includes, upon determining that the container is empty, reporting to an automated storage and retrieval system (AS/RS) that the container is empty.

In a thirteenth aspect, the present invention provides a system for detecting empty container. The system includes a perturbation device for perturbing a content of a container, and an imaging system for acquiring a first image and a second image of the container. The first image is acquired before the perturbation, and the second image is acquired after the perturbation. The system further includes one or more computer processors. The one or more computer processors are configured to process the first image and the second image to determine whether the container is empty based on whether there is a difference between the first image and the second image as a result of one or more objects inside the container being moved due to the perturbation.

In a fourteenth aspect, the present invention provides the system according to the thirteenth aspect, wherein the imaging system includes one or more cameras, or one or more ultrasonic sensors, or one or more radars, or one or more lidars, or a combination thereof.

In a fifteenth aspect, the present invention provides the system according to the thirteenth aspect, wherein the imaging system includes two RGBD cameras.

In a sixteenth aspect, the present invention provides the system according to the thirteenth aspect, wherein the perturbation device includes a nozzle for blowing air inside the container.

In a seventeenth aspect, the present invention provides the system according to the thirteenth aspect, wherein the perturbation device includes a robot end effector configured to be moved along an inside of the container in a stirring motion, and/or a shaker for shaking the container, and/or a tilting stage for tilting the container.

In an eighteenth aspect, the present invention provides the system according to the thirteenth aspect, wherein processing the first image and the second image includes comparing the first image and the second image by evaluating a value of a mean squared error (MSE) function between the first image and the second image, determining that the container is empty upon determining that the value of the MSE function is less than a pre-defined threshold value, and determining that the container is not empty upon determining that the value of the MSE function is equal to or greater than the pre-defined threshold value.

In a nineteenth aspect, the present invention provides the system according to the thirteenth aspect, wherein processing the first image and the second image includes comparing the first image and the second image by evaluating a value of a structural similarity index measure (SSIM) function between the first image and the second image, determining that the container is empty upon determining that a difference between the value of the SSIM function and unity is less than a pre-defined threshold amount, and determining that the container is not empty upon determining that the difference between the value of the SSIM function and unity is equal to or greater than the pre-defined threshold amount.

In a twentieth aspect, the present invention provide a tangible, non-transitory computer-readable medium having instructions thereon which, upon being executed by one or more hardware processors, alone or in combination, provide for execution of the method according to the first aspect.

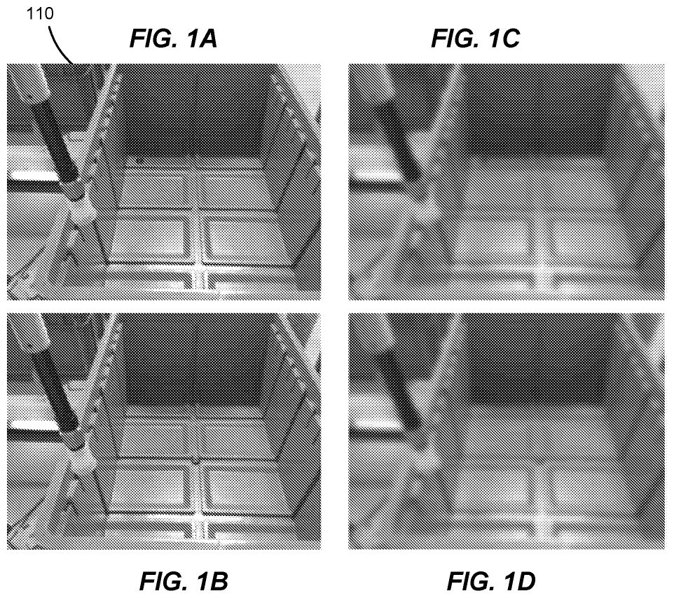

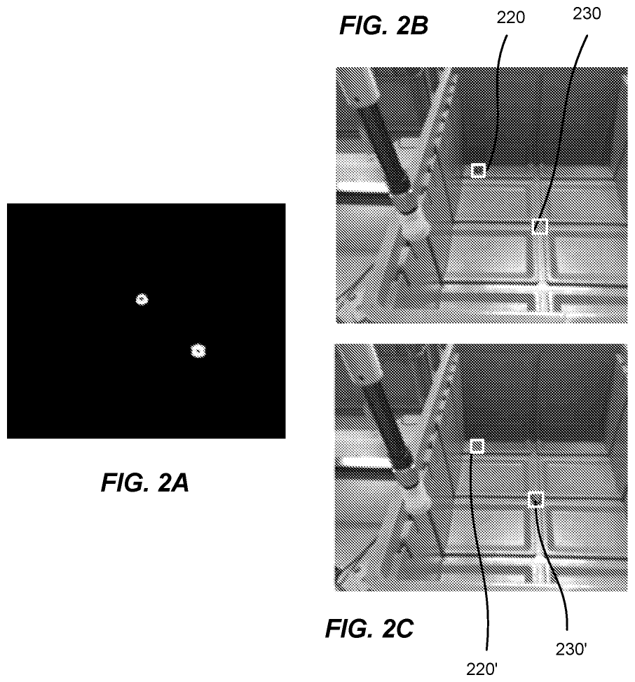

FIGS. 1A-1D and 2A-2C illustrate an image processing method according to some embodiments. FIGS. 1A and 1B show the raw images of an open-top container 110, before and after a perturbation, respectively. If the raw images are color images (e.g., RGB images), the raw images can be converted into greyscale images. In some embodiments, a blur function such as a Gaussian filter can be applied to the greyscale images, producing the blurred images shown in FIGS. 1C and 1D. The Gaussian blur can suppress artifacts due to spurious high-frequency information. The steps of converting into greyscale images and applying the Gaussian filter are optional.

The blurred images shown in FIGS. 1C and 1D can be compared with each other using either the MSE method or the SSIM method. A pre-determined threshold value can be used to determine whether the two images are different. For example, in the SSIM method, if the SSIM value is less than one by an amount that exceeds a pre-determined threshold, it can be determined that the two images are different. In the MSE method, if the MSE value is greater than zero by an amount that exceeds a pre-determined threshold, it can be determined that the two images are different.

FIG. 2A shows the regions in the two images identified as different in white, and the rest of the regions in black (using either the SSIM method or the MSE method). For example, the regions with SSIM values that differ from one by an amount exceeding the threshold can be labeled with “1,” and the rest of the regions can be labeled with “0.” The regions identified as different can be visualized by drawing bounding boxes in the raw images, as shown in FIGS. 2B (before perturbation) and 2C (after perturbation). In this example, a small wheel (e.g., as small as 2 mm high) was in the bounding box 220 before perturbation (as shown in FIG. 2B), and is moved into the bounding box 230′ after perturbation (as shown in FIG. 2C).

In exemplary tests for the example illustrated in FIGS. 1A-1D and 2A-2C, the MSE value between the two images is 145.25, and the SSIM value is 0.92. In the tests, the container is perturbed by blowing air through a nozzle of a robot end effector. To ensure that the perturbation would affect objects anywhere in the container, air is blown in the four corners of the container.

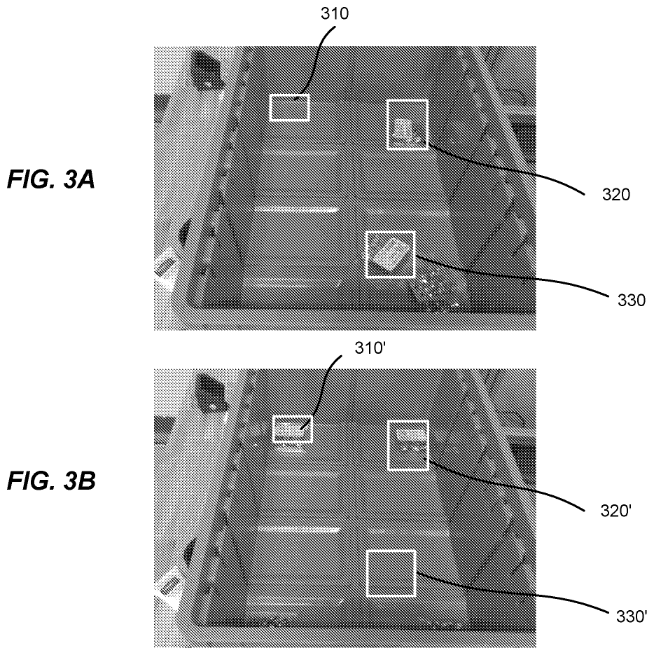

FIGS. 3A and 3B show images of a container, before and after a perturbation, respectively, in another test. The bounding boxes 310/310′, 320/320′, and 330/330′ are shown in FIGS. 3A and 3B to illustrate regions in which the two images differ. As illustrated, the object in the bounding box 330 before the perturbation is moved to the bounding box 310′ after the perturbation. The object in the bounding box 320 is also shifted slightly in the bounding box 320′ after the perturbation.

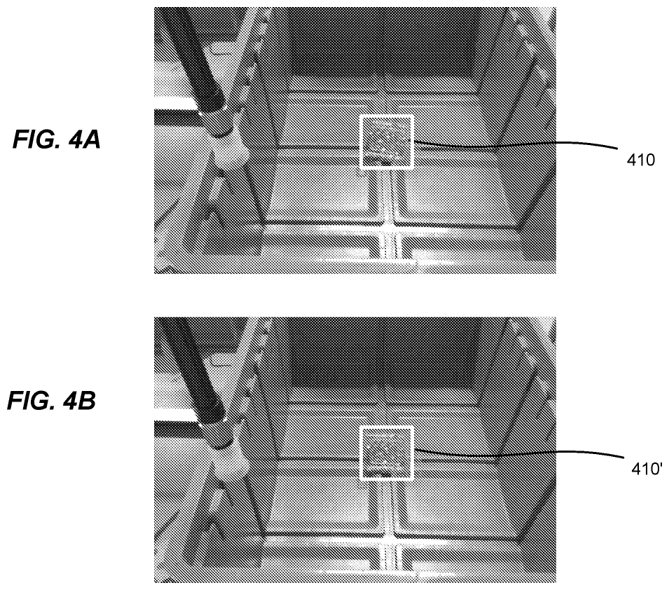

FIGS. 4A and 3B show images of a container, before and after a perturbation, respectively, in yet another test. The bounding box 410/410′ is shown in FIGS. 4A and 4B to illustrate a region in which the two images differ. As illustrated, the object in the bounding box 410 before the perturbation is rotated in the bounding box 410′ after the perturbation (e.g., by about 10 degrees). This test illustrate that the method according to embodiments of the present invention can be sensitive to a slight rotation of an object, even without a translation of the object.

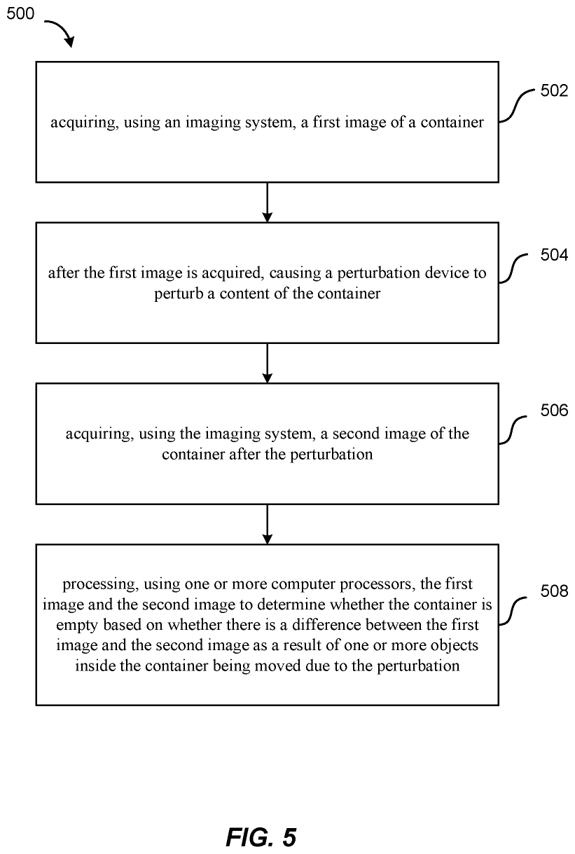

FIG. 5 is a flowchart illustrating a computer-implemented method 500 for detecting empty container according to some embodiments. At 502, a first image of a container is acquired using an imaging system. At 504, after the first image is acquired, a content of the container is perturbed using a perturbation device. At 506, after the perturbation, a second image of the container is acquired using the imaging system. At 508, the first image and the second image are processed using one or more computer processors to determine whether the container is empty based on whether there is a difference between the first image and the second image as a result of one or more objects inside the container being moved due to the perturbation.

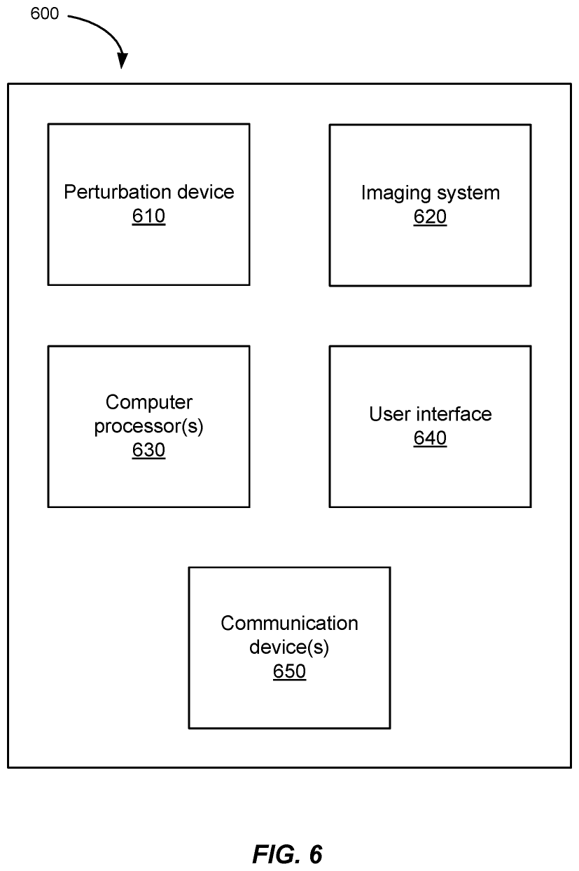

FIG. 6 is a simplified block diagram of a system 600 for detecting empty container according to some embodiments. The system can include a perturbation device 610 for perturbing a container, and an imaging system 620 for acquiring a first image of the container before the container is perturbed, and a second image of the container after the container has been perturbed. According to various embodiments, the imaging system 620 can include one or more cameras, or one or more ultrasonic sensors, or one or more radars, or a combination thereof. The cameras can be two-dimensional cameras or three-dimensional cameras, or a combination thereof. According to an embodiment, the imaging system includes two RGBD cameras.

The system 600 further includes one or more computer processors 630. The computer processors are configured to process the first image and the second image to determine whether the container is empty, as described above. The system 600 can further include a user interface 640. The user interface 640 can include a display screen (e.g., a touch-sensing screen) for receiving input from and displaying output to users. The system 600 can further include communication device(s) 650, which can include wired communication devices and/or wireless communication devices. The perturbation device 610, the imaging system 620, the computer processor(s) 630, the user interface 640 can be communicatively coupled with each other via wires, buses, and/or the communication devices 650.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for detecting empty container, the method comprising:
acquiring, using an imaging system, a first image of a container;
after the first image is acquired, causing a perturbation device to perturb a content of the container;
acquiring, using the imaging system, a second image of the container after the perturbation; and
processing, using one or more computer processors, the first image and the second image to determine whether the container is empty based on whether there is a difference between the first image and the second image as a result of one or more objects inside the container being moved due to the perturbation.

2. The method of claim 1, wherein the perturbation is performed by blowing air inside the container.

3. The method of claim 1, wherein the perturbation is performed by moving a robot end effector along an inside of the container in a stirring motion.

4. The method of claim 1, wherein the perturbation is performed by shaking or tilting the container.

5. The method of claim 1, wherein the first image and the second image are acquired under a same set of environmental conditions.

6. The method of claim 1, wherein processing the first image and the second image comprises:
comparing the first image and the second image by evaluating a value of a mean squared error (MSE) function between the first image and the second image;
determining that the container is empty upon determining that the value of the MSE function is less than a pre-defined threshold value; and
determining that the container is not empty upon determining that the value of the MSE function is equal to or greater than the pre-defined threshold value.

7. The method of claim 6, wherein processing the first image and the second image further comprises, before evaluating the value of the MSE function, applying a blur function to the first image and the second image.

8. The method of claim 6, wherein processing the first image and the second image further comprises, before evaluating the value of the MSE function, converting the first image and the second image into greyscale images.

9. The method of claim 1, wherein processing the first image and the second image comprises:
comparing the first image and the second image by evaluating a value of a structural similarity index measure (SSIM) function between the first image and the second image;
determining that the container is empty upon determining that a difference between the value of the SSIM function and unity is less than a pre-defined threshold amount; and
determining that the container is not empty upon determining that the difference between the value of the SSIM function and unity is equal to or greater than the pre-defined threshold amount.

10. The method of claim 9, wherein processing the first image and the second image further comprises, before evaluating the value of the SSIM function, applying a blur function to the first image and the second image.

11. The method of claim 9, wherein processing the first image and the second image further comprises, before evaluating the value of the SSIM function, converting the first image and the second image into greyscale images.

12. The method of claim 1, further comprising, upon determining that the container is empty, reporting to an automated storage and retrieval system (AS/RS) that the container is empty.

13. A system for detecting empty container, the system comprising:
a perturbation device for perturbing a content of a container;
an imaging system for acquiring a first image and a second image of the container, the first image being acquired before the perturbation, and the second image being acquired after the perturbation; and
one or more computer processors configured to process the first image and the second image to determine whether the container is empty based on whether there is a difference between the first image and the second image as a result of one or more objects inside the container being moved due to the perturbation.

14. The system of claim 13, wherein the imaging system comprises one or more cameras, or one or more ultrasonic sensors, or one or more radars, or one or more lidars, or a combination thereof.

15. The system of claim 13, wherein the imaging system comprises two RGBD cameras.

16. The system of claim 13, wherein the perturbation device comprises a nozzle for blowing air inside the container.

17. The system of claim 13, wherein the perturbation device comprises a robot end effector configured to be moved along an inside of the container in a stirring motion, and/or a shaker for shaking the container, and/or a tilting stage for tilting the container.

18. The system of claim 13, wherein processing the first image and the second image comprises:
comparing the first image and the second image by evaluating a value of a mean squared error (MSE) function between the first image and the second image;
determining that the container is empty upon determining that the value of the MSE function is less than a pre-defined threshold value; and
determining that the container is not empty upon determining that the value of the MSE function is equal to or greater than the pre-defined threshold value.

19. The system of claim 13, wherein processing the first image and the second image comprises:
comparing the first image and the second image by evaluating a value of a structural similarity index measure (SSIM) function between the first image and the second image;
determining that the container is empty upon determining that a difference between the value of the SSIM function and unity is less than a pre-defined threshold amount; and
determining that the container is not empty upon determining that the difference between the value of the SSIM function and unity is equal to or greater than the pre-defined threshold amount.

20. A tangible, non-transitory computer-readable medium having instructions thereon which, upon being executed by one or more hardware processors, alone or in combination, provide for execution of the method of claim 1.
